(19) United States
(12) Patent Application Publication
(10) Pub. No.: US 2018/0373548 A1
(43) Pub. Date: Dec. 27, 2018

(54) System And Method For Configuring Equipment That Is Reliant On A Power Distribution System

(71) Applicant: Sunbird Software, Inc., Somerset, NJ (US)

(72) Inventor: Samer Yousef Nassoura, Madison, NJ (US)

(73) Assignee: Sunbird Software, Inc., Somerset, NJ (US)

(21) Appl. No.: 15/633,577

(22) Filed: Jun. 26, 2017

(51) Int. Cl. G06F 9/445; H04Q 9/00; G06F 1/32

(52) U.S. Cl. CPC G06F 9/44505; H04Q 9/00; H04Q 2209/60; H04Q 2213/002; G06F 1/3215

(57) ABSTRACT

A system and method for configuring data-center equipment that is reliant on a power distribution system. A data-processing system receives an indication of a device whose electrical power is being configured. The data-processing system identifies a plurality of candidate electrical outlets that are available for use and then evaluates those candidate outlets. The data-processing system can evaluate the candidate outlets based on one or more of i) the metadata of each electrical outlet in the plurality of candidate outlets, ii) the power redundancy associated with each electrical outlet, and iii) the power capacity associated with a power chain of each electrical outlet. This results in a set of identifiers of qualifying candidate electrical outlets. The data-processing system can rank the outlets in terms of their distances from the device and/or effects on electrical phase balance. The data-processing system then displays identifiers of the ranked, qualifying outlets.

### FIELD OF THE INVENTION

The present invention relates to power distribution systems in general, and, more particularly, to a power distribution system in a data center and to configuring the equipment that is reliant on the power distribution system.

### BACKGROUND OF THE INVENTION

The electronic exchange of data is required for almost every type of business transaction. As the demand for instant data delivery increased, data centers were created to handle the influx of requests for data. A data center is a facility that is used to house computer systems, including servers, and associated components, such as network communications and storage systems. The computer servers are capable of processing, storing, and distributing large amounts of data. The data center generally also includes redundant or backup power supplies, redundant data communications connections, environmental controls (e.g., air conditioning, fire suppression, etc.), and various security devices.

Conventionally, the computer servers are mounted in racks and supplied with power through a power distribution system. The power distribution system includes a mains power supply that serves as the source of electrical power within the data center and distributes power to one or more floor PDUs. A floor PDU has one or more power panels comprising circuit breakers, in which each circuit breaker is electrically connected to cabling leading to a power outlet that adjoins (e.g., is underneath, is above, etc.) a rack cabinet.

Each rack PDU associated with a rack cabinet is electrically connected to the cabinet power outlet and is supplied with line power from the power outlet. The rack PDU provides the line power to the power supplies of various electronic devices that are mounted in a rack or computer cabinet to which the rack PDU is also mounted. The rack PDU has a plurality of female line-voltage receptacles, or “outlets,” for supplying line power to, for example, the computer servers, modems, and routers that are mounted in the rack.

Rack PDUs can monitor the power drawn from each power outlet, in that they have “outlet level” power monitoring or metering. Having this monitoring makes it possible to, for example, determine the power being drawn by a particular computer server or other device.

An operator, such as a technician, who manages a data center must continually monitor and assess various systems, including those related to cooling, security, space, and electrical power distribution. Managing the various systems within a data center can be challenging to the operator, considering that there are typically tens of thousands of equipment components that must be accounted for. Moreover, the operator experiences an ongoing problem of often having only a limited understanding of resource availability, especially given the number of components and the complexity in which they are interrelated. With respect to understanding electrical power resources, the operator having a limited understanding is prone to making errors. Such errors can include, for example, failing to achieve diversity in terms of how a server or other device is supplied with power, overloading one or more power distribution units within the data center, and, in general, oversubscribing one or more power chains throughout the data center.

What is needed is an improved technique of configuring equipment that is reliant on a power distribution system, without at least some of the disadvantages in the prior art.

### SUMMARY OF THE INVENTION

The present invention enables the management and visualization of data center assets, particularly with regard to configuring how electrical power is distributed to one or more rack-mounted devices, such as computer servers, and how such devices are positioned within the racks and in relation to the power distribution system.

A data-processing system disclosed herein initializes an assets database that describes the assets within a data center, including electrical outlets, rack power distribution units (PDU) comprising the electrical outlets, servers and other devices that are mountable in rack cabinets, and the rack cabinets. The data-processing system receives an indication of a device whose electrical power is being configured, by an operator such as a technician. The data-processing system identifies a plurality of candidate electrical outlets that are available for use and then evaluates those candidate outlets. The data-processing system can evaluate the candidate outlets based on one or more of i) the metadata of each electrical outlet in the plurality of candidate outlets, in relation to the metadata of the device, ii) the power redundancy associated with each electrical outlet in the plurality, and iii) the power capacity associated with a power chain of each electrical outlet in the plurality. The metadata that is evaluated can include one or more of voltage, amperage, electrical phase, connector type, and color code.

The evaluating of the candidate outlets results in a set of identifiers of qualifying candidate electrical outlets. The data-processing system then orders the set of identifiers by, for example, ranking the outlets in terms of their distances from the device. As another example, the data-processing system can order the set of identifiers by ranking the outlets in terms of their projected effects on power loading along one or more power chains. The ranking can account for the power loading on each phase of electrical power in each power chain, and can be based on an objective of how well the loads are balanced across the phases in a polyphase (e.g., three-phase, etc.) power chain. The data-processing system then displays at least some of ordered identifiers of the qualifying candidate electrical outlets, along with the identifier of the device whose power is being configured.

In a different operating scenario, the data-processing system receives an indication of a device that is being installed. The data-processing system evaluates various assets at the data center, including available electrical outlets, available physical space within a plurality of rack cabinets, and the device being installed. This process results in a set of identifiers of qualifying device positions that are within one or more rack cabinets. The data-processing system then displays at least some of the identifiers of the qualifying device positions, along with the identifier of the device being installed.

The disclosed system and method are advantageous, in that they evaluate the power redundancy and power loading that need to be considered when configuring equipment at a data center. This can save an operator time and decrease the probability of errors being committed.

An illustrative method comprises: storing in a database, by a data-processing system, identifiers of electrical outlets and identifiers of one or more devices; receiving, by the data-processing system, an indication of a first device whose electrical power is being configured, wherein the first device is rack-mountable; identifying, by the data-processing system, a plurality of candidate electrical outlets that are available for use; evaluating, by the data-processing system, i) metadata of each electrical outlet in the plurality of candidate electrical outlets, in relation to metadata of the first device, and ii) power redundancy associated with each electrical outlet in the plurality of candidate electrical outlets in relation to the first device, resulting in a non-empty set of qualifying candidate electrical outlets; ordering, by the data-processing system, the set of identifiers that correspond to the qualifying candidate electrical outlets; and displaying on a video display, by the data-processing system, the set of ordered identifiers of the qualifying candidate electrical outlets and the identifier of the first device.

Another illustrative method comprises: storing in a database, by a data-processing system, identifiers of electrical outlets and identifiers of one or more devices; receiving, by the data-processing system, an indication of a first device whose electrical power is being configured, wherein the first device is rack-mountable; identifying, by the data-processing system, a plurality of candidate electrical outlets that are available for use; evaluating, by the data-processing system, i) metadata of each electrical outlet in the plurality of candidate electrical outlets, in relation to metadata of the first device, and ii) power capacity associated with a power chain of each electrical outlet in the plurality of candidate electrical outlets in relation to the first device, resulting in a non-empty set of qualifying candidate electrical outlets, wherein the evaluating of the power capacity is based on power-metering information that is received by the data-processing system from at least one power distribution unit (PDU); ordering, by the data-processing system, the set of identifiers that correspond to the qualifying candidate electrical outlets; and displaying on a video display, by the data-processing system, the set of ordered identifiers of the qualifying candidate electrical outlets and the identifier of the first device.

Yet another illustrative method comprises: storing in a database, by a data-processing system, identifiers of a plurality of rack cabinets, electrical outlets, and one or more devices, wherein the devices are rack-mountable; receiving, by the data-processing system, an indication of a first device that is being positioned within the plurality of rack cabinets; identifying, by the data-processing system, a plurality of electrical outlets that are available for use, wherein availability information for at least some of the electrical outlets is derived from signals that are received by the data-processing system from at least one power distribution unit (PDU); evaluating, by the data-processing system, i) metadata of each electrical outlet in the plurality of candidate electrical outlets, in relation to metadata of the first device, and ii) physical space available within each rack cabinet in the plurality of rack cabinets, in relation to the first device, resulting in a non-empty set of qualifying candidate device positions; ordering, by the data-processing system, the set of identifiers that correspond to the qualifying candidate device positions; and displaying on a video display, by the data-processing system, the set of ordered identifiers of the qualifying candidate device positions and the identifier of the first device.

### BRIEF DESCRIPTION OF THE DRAWINGS

FIG. 1 depicts a floor plan of at least some of the equipment constituting data center 100.

FIG. 2 depicts an equipment diagram of rack cabinets 141 and 142, and also at least some of the equipment associated with these cabinets, including asset management system 291.

FIG. 3 depicts tree graph 300 that is representative of electrical power distribution throughout data center 100.

FIG. 4 depicts a block diagram of the salient components of asset management system 291, including data-processing system 401.

FIG. 5 depicts a block diagram of the salient components of data-processing system 401.

FIG. 6 depicts a flowchart of the salient processes of method 600 for configuring how electrical power is distributed.

FIG. 7 depicts the sub-operations within operation 605 of method 600, related to evaluating a set of available electrical outlets in relation to selected device i.

FIG. 8 depicts the sub-operations within operation 607 of method 600, related to ordering a set of qualifying candidate outlets for presentation to the operator.

FIG. 9 depicts a flowchart of the salient processes of method 900 for configuring, within a group of rack cabinets, devices to which electrical power is provided.

### DETAILED DESCRIPTION

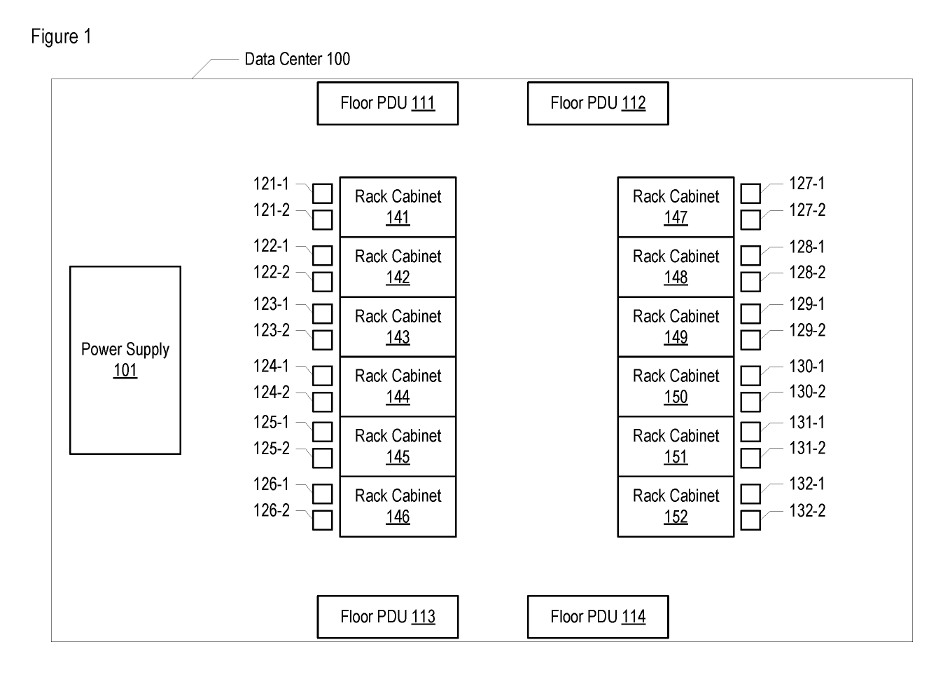

FIG. 1 depicts a floor plan of at least some of the equipment constituting data center 100, in accordance with an illustrative embodiment of the present invention. Data center 100 is a facility that is used to house computer systems and associated components. As depicted, data center 100 comprises mains power supply 101, floor-mounted power distribution units 111 through 114, cabinet power outlets 121-h through 132-h, wherein h as depicted has a value of 1 or 2, and equipment rack cabinets 141 through 152, situated as shown. Data center 100 further comprises data communications connections, environmental controls such as air conditioning and fire suppression, and security devices, which for clarity purposes are not depicted in FIG. 1.

For simplicity, FIG. 1 shows one mains power supply, four floor-mounted power distribution units, and twelve rack cabinets in data center 100. In actuality, a data center routinely comprises thousands of servers. Additionally, FIG. 1 does not depict the electrical-power connectivity between the depicted elements, which connectivity is well known and can be made and used by persons having skill in the art. And as those who are skilled who are skilled in the art will appreciate after reading this specification, other equipment units can be present through which electrical power flows, in addition to or instead of at least some of the depicted elements.

Mains power supply 101 is an electrical apparatus that receives electrical power from an external source, also known as “mains power,” and makes the power available to various electrical equipment within data center 100. In some embodiments of the present invention, power supply 101 can provide an uninterruptible power supply (UPS) function, which is used to provide emergency power to the equipment within data center 100 when the mains power source fails. Power supply 101 can also be used to protect the electrical equipment within data center 100 from unexpected power disruption.

Floor-mounted power distribution units (PDU) 111, 112, 113, and 114 each distributes electrical power received from power supply 101 to one or more rack cabinets, such as rack cabinets 141 through 152. For example, floor PDU 111 receives power from power supply 101 and transforms the raw power feed into any number of lower capacity, distributed power feeds. Floor PDU 111 can require multiple high-current circuits possibly from different electrical phases of incoming power from supply 101. Each floor PDU can comprise main breakers, individual circuit breakers, and power monitoring panels.

FIG. 1 depicts floor-based power distribution in the form of floor PDUs 111 through 114. As those who are skilled in the art will appreciate after reading this specification, floor-based power distribution can be in the form of other equipment units such as, while not being limited to, a power distribution rack (PDR), a remote power panel (RPP), and so on, which can be present in addition to or instead of some or all of the depicted floor PDUs.

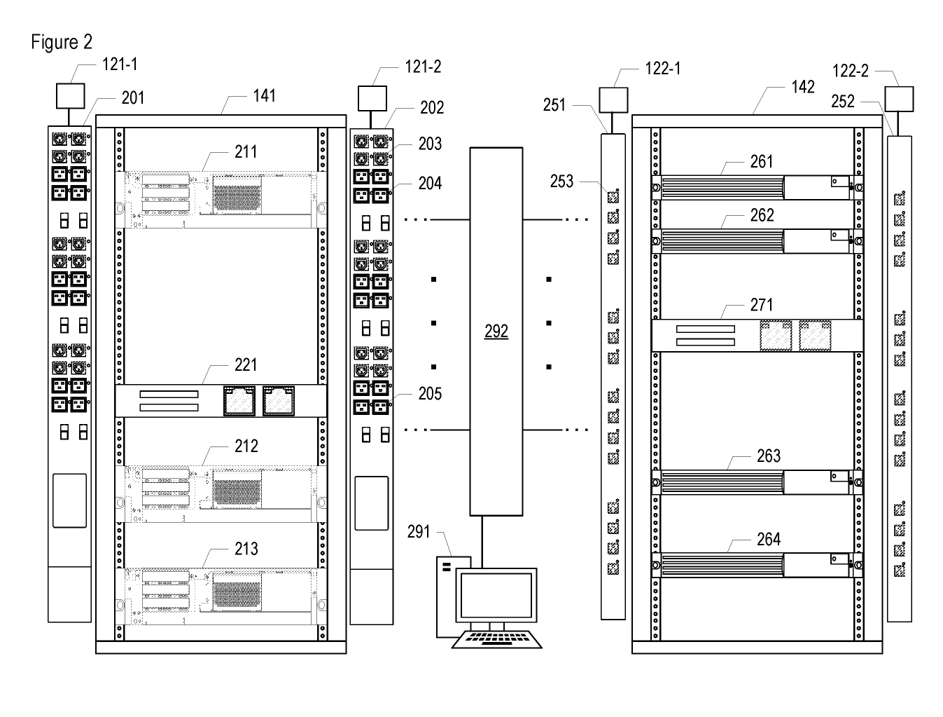

Rack cabinets 141 through 152 are enclosures for mounting multiple electronic equipment units, which are also referred to as “devices.” Each rack cabinet is also referred to as a “rack”, in particular where the cabinet comprises a standardized frame for mounting the multiple units. Rack cabinets 141 and 142 as described in detail below and in regard to FIG. 2.

Each rack cabinet depicted in FIG. 1 houses one or more rack PDUs. A rack PDU distributes electrical power received from a floor-mounted PDU, such as floor PDUs 111 through 114, to one or more devices that are mounted within the rack cabinet. For example, a rack PDU is fitted with multiple electrical outlets that are designed to provide power to units within the host rack cabinet. (The terms “electrical outlet” and “power outlet” are used interchangeably throughout this specification.)

The rack PDUs that are associated with a rack cabinet receive their power through one or more power outlets that are associated with each cabinet. As depicted in FIG. 1, cabinet power outlets 121-h through 132-h are associated with rack cabinets 141 through 152, respectively. Each cabinet power outlet, also known as a “whip,” is electrically connected to a floor PDU and, as such, receives electrical power from that floor PDU. A cabinet power outlet can be situated above (i.e., in or near the ceiling) or below (i.e., in or near the floor) its corresponding rack cabinet. A rack PDU is electrically connected to the power outlet that is providing power to that rack PDU.

One or more of the depicted rack cabinets further comprise one or more computer servers, also referred to as “servers.” A server is a device that provides functionality to other devices, such as clients that are not part of data center 100 but which exchange information with programs being executed by the server. Each server mounted within rack cabinets 141 through 152 can provide one or more functionalities such as database, file storage, email, printing web, gaming, and applications functionality, for example and without limitation. One or more of the depicted rack cabinets can comprise types of electronic devices other than or in addition to servers and rack PDUs.

FIG. 2 depicts an equipment diagram of rack cabinets 141 and 142, and also at least some of the equipment associated with these cabinets, in accordance with the illustrative embodiment. As depicted, associated with rack cabinet 141 are rack PDUs 201 and 202, servers 211, 212, and 213, and power monitoring appliance 221, all of which are mounted near or within cabinet 141. Additionally, associated with cabinet 142 are rack PDUs 251 and 252, servers 261, 262, 263, and 264, and power monitoring appliance 271, all of which are mounted near or within cabinet 142. Also associated with rack cabinets 141 and 142 are asset management system 291 and local-area network 292, interconnected to each other as shown.

One or both of rack PDUs 201 and 202, which are mounted to rack 141, supply power to each of servers 211, 212, and 213 and to power-monitoring appliance 221, described in more detail below. For clarity purposes, FIG. 2 depicts the rack PDUs as being separate from the rack cabinets to which they are mounted and does not depict the power cabling between each rack device and a power outlet on a rack PDU.

Rack PDUs 201 and 202 are each fitted with multiple electrical outlets designed to provide power to devices within rack cabinet 141. For example, PDU 202 is fitted with outlets 203, 204, and 205, as well as others. Rack PDUs 201 and 202 each is capable of outlet-level power monitoring and switching capability, and, therefore, can measure and report the individual power consumption of each of servers 211, 212, and 213, and appliance 221.

Rack PDUs 201 and 202 themselves are electrically connected to cabinet power outlets 121-1 and 121-2, respectively, which outlets provide electrical power to those rack PDUs. Each of rack PDUs 201 and 202 is capable of input power monitoring and, therefore, can measure and report the power that it draws from the upstream power chain that it is part of.

Similarly, one or both of PDUs 251 and 252 supply power to each of servers 261, 262 and 263, and 264, and also to power-monitoring appliance 271. Rack PDUs 251 and 252 are each fitted with multiple electrical outlets designed to provide power to devices within rack cabinet 142, including outlet 253 of PDU 251 as an example. Rack PDUs 251 and 252 each is capable of outlet-level power monitoring and switching capability, and, therefore, can measure and report the individual power consumption of each of servers 261, 262, 263, and 264, and appliance 271. PDUs 251 and 252 can be, but need not be, the same as PDUs 201 and 202. For that matter, 251 and 252 need not be identical to each other.

Rack PDUs 251 and 252 themselves are electrically connected to cabinet power outlets 122-1 and 122-2, respectively, which outlets provide electrical power to those rack PDUs. As are PDUs 201 and 202, each of PDUs 251 and 252 is capable of input power monitoring and, therefore, can measure and report the power that it draws from the upstream power chain that it is part of.

Data center 100 comprises servers 211, 212 and 213, which are mounted in rack 141, and servers 261, 262, 263, and 264, which are mounted in rack 142. For illustrative purposes, servers 211 through 213 are Windows™-enabled servers and servers 261 through 264 are UNIX™-enabled servers. As those who are skilled in the art will appreciate after reading this specification, however, other types of servers can also be present such as, while not being limited to, those running on Linux™, Solaris™, HP-UX™. Additionally, the servers depicted in FIG. 2 need not be identical to one another, even in regard to features other than the particular operating system that each server is running.

Power-monitoring appliances 221 and 271 each executes a power-monitoring program. Once such program is the Power IQ® program by Sunbird Software, Inc. This program can monitor the power consumption of tens of thousands of servers and present power usage information to an operator (e.g., a technician, etc.) via a web browser at asset management system 291. In some embodiments of the present invention, a single power-monitoring appliance can be associated with multiple racks, in contrast to each power-monitoring appliance corresponding to each rack as depicted.

Typically, a rack device that consumes electrical power, such as server 211 or power-monitoring appliance 221, is plugged into an available outlet on a rack PDU, using the device's power cable, which is also electrically connected to an onboard power supply of the device. At least some of the depicted rack devices have multiple, onboard power supplies, wherein each power supply has its own power cable and each power cable is plugged into an available outlet on a rack PDU. Where there are multiple power supplies that make up a given power-consuming device, the multiple power cables can be plugged into available outlets on the same rack PDU or can be plugged into available outlets on different rack PDUs (i.e., to achieve diversity in supply power).

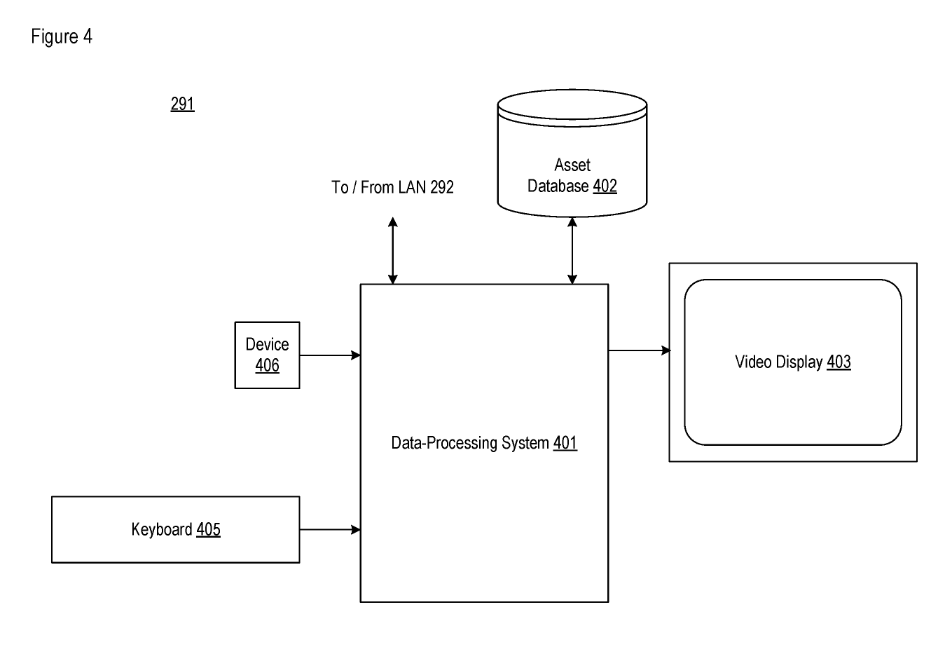

Asset management system 291 executes one or more software programs that carry out a method in accordance with the illustrative embodiment, in addition to receiving and displaying information from one or more devices in racks 141 and 142. Asset management system 291 is described in more detail below and in regard to FIG. 4.

Within a data-networking context, local area network (LAN) 292 comprises equipment that connects servers 211 through 213 and 261 through 264 to one other and to power-monitoring appliances 221 and 271. A primary function of LAN 292 is to parcel out computing operations to the servers 211 through 213 and 261 through 264, and to make the results of such operations available to one or more systems (not shown).

In accordance with the illustrative embodiment, LAN 292 also supports the operation of PDUs 201, 202, 251, and 252, as well as other devices within data center 100, by providing a computer network that is capable of exchanging data amongst the devices that are connected to the LAN. In particular, LAN 292 conveys individual power consumptions of the servers 211 through 213 and 261 through 264, as measured by the rack PDUs, to power monitoring appliances 221 and 271. In some embodiments of the present invention, LAN 292 conveys power consumption as measured by other power-handling equipment, such as floor PDUs 111 through 114, to one or more power monitoring appliances. In some embodiments of the present invention, LAN 292 conveys power consumption information, as well as other information, directly to system 291.

The specific connectivity associated with LAN 292 is not described, nor does description provided herein specify the details of the computer network or networks used within data center 100, except where specifically required to describe or enable the present invention. Computer networks are well known and persons having skill in the art will be able to make and use such networks appropriate to the intended application.

In accordance with the illustrative embodiment, LAN 292 provides an Ethernet-based network. Alternatively, LAN 292 can provide a wireless network and/or can use protocols such as, while not being limited to, Simple Network Management Protocol (SNMP), Modbus, Intelligent Platform Management Interface (IPMI), and Transmission Control Protocol/Internet Protocol (TCP/IP).

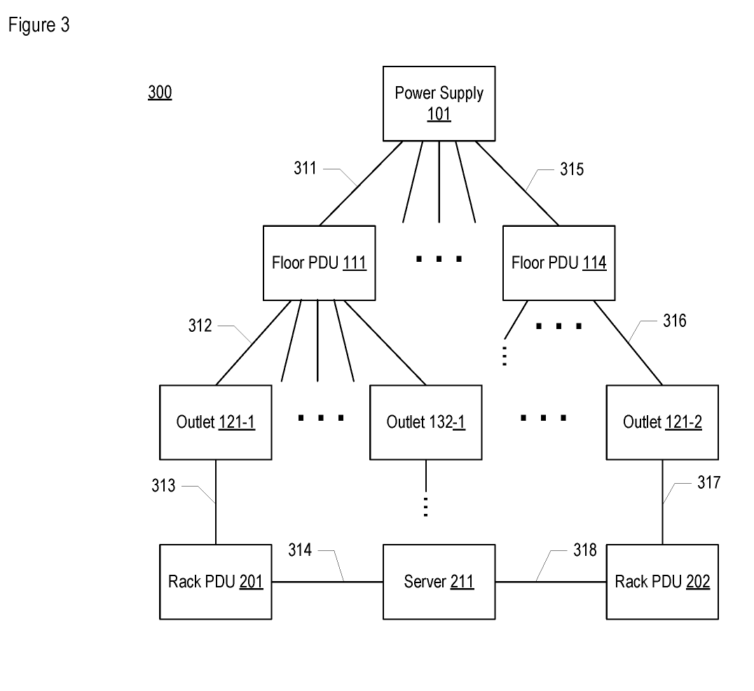

FIG. 3 depicts tree graph 300 that is representative of electrical power distribution throughout data center 100, in accordance with the illustrative embodiment. Graph 300 comprises vertices that correspond to the mains power supply, the floor PDUs, the power outlets, and the rack PDUs described above and in regard to FIGS. 1 and 2. For clarity purposes, only a subset of the equipment is depicted in FIG. 3.

The graph further comprises edges that correspond to electrical power paths. Specifically, each edge corresponds to a power path between a pair of vertices. As depicted and in a first power chain, power path 311 provides electrical power from power supply 101 to floor PDU 111, power path 312 provides electrical power from floor PDU 111 to outlet 121-1, power path 313 provides electrical power from outlet 121-1 to rack PDU 201, and power path 314 provides electrical power from rack PDU 201 to server 211 mounted in rack cabinet 141. In other words, the first power chain leading up to server 211 comprises the foregoing vertices and edges between power supply 101 and rack PDU 201, inclusive.

In the example illustrated, server 211 is being provided power by rack PDU 201 through power path 314. Server 211, having power redundancy, is also being provided power by rack PDU 202 through power path 318. In a second power chain that provides the power redundancy, power path 315 provides electrical power from power supply 101 to floor PDU 114, power path 316 provides electrical power from floor PDU 114 to outlet 121-2, power path 317 provides electrical power from outlet 121-2 to rack PDU 202, and power path 318, as already stated, provides redundant electrical power from rack PDU 202 to server 211. In other words, the second power chain leading up to server 211 comprises the foregoing vertices and edges between power supply 101 and rack PDU 202, inclusive.

Although server 211 is depicted as receiving its electrical power through two paths, those who are skilled in the art will appreciate, after reading this specification, that server 211 can receive its electrical power through a different number of paths (e.g., one, three, etc.) than depicted.

The depicted graph in FIG. 3 shows a particular configuration of vertices consuming and/or distributing electrical power and the edges along which electrical power is being supplied. As those who are skilled in the art will appreciate after reading this specification, however, some or all of the equipment units within data center 100 can be provided with electrical power in accordance with a different configuration than that depicted in FIG. 3. Furthermore, the depicted graph shows a particular set of equipment units at the vertices and a particular number of hierarchical levels in the graph. As those who are skilled in the art will appreciate after reading this specification, however, different types of equipment can be featured at one or more of the vertices, or a different number of levels can exist within a data-center equipment hierarchy represented in the graph, or both.

FIG. 4 depicts a block diagram of the salient components of asset management system 291, in accordance with the illustrative embodiment. Asset management system 291 comprises: data-processing system 401, assets database 402, video display 403, keyboard 405, and pointing device 406, interconnected as shown.

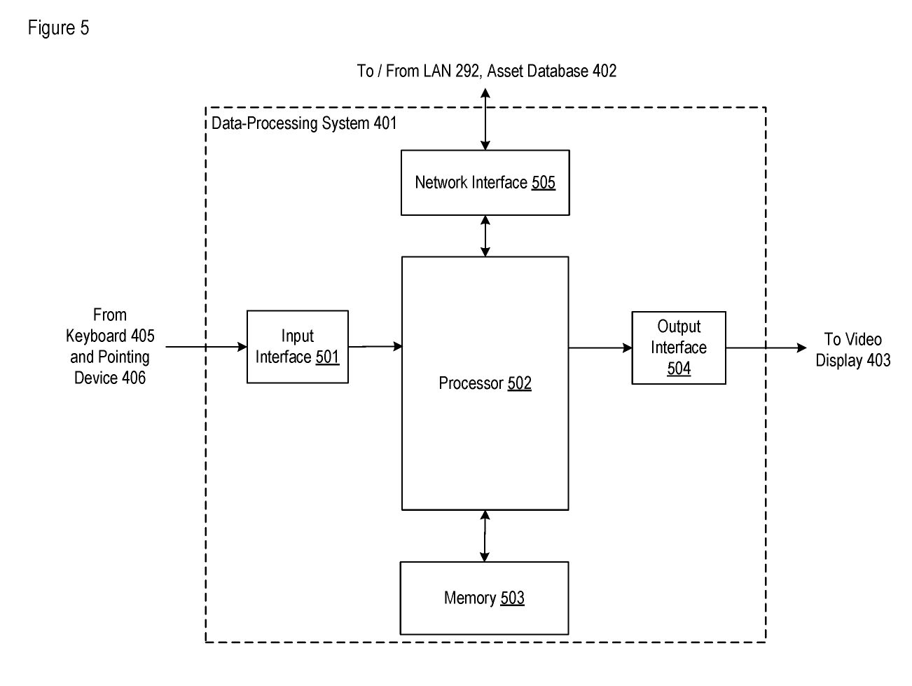

Data-processing system 401 is a general-purpose computer that comprises a processor, memory, and input and output interfaces for an operator interface. Data-processing system 401 is capable of performing the operations described below. Data-processing system 401:
i. receives one or more datasets from, and updates one or more datasets stored in, assets database 402, and
iii. receives a keyboard signal from keyboard 405, comprising an operator input control, and
iii. receives a pointing and command signal from pointing device 406, comprising an operator input control, and
iv. outputs a video signal to video display 403 to present information to an operator, including one or more power paths with which to connect components to each other within data center 100 and/or one or more device positions within a group of rack cabinets at which to install a device.
   Data-processing system 401 is further depicted in FIG. 5.

Assets database 402 describes at least some characteristics of at least some of the assets within data center 100. The assets described within database 402 can include, for example and without limitation, identifiers of and/or one or more features of:
i. servers 211 through 213 and 261 through 264 (e.g., position within a cabinet, etc.), and
ii. power monitoring appliances 221 and 271 (e.g., position within a cabinet, etc.), and
iii. rack PDUs 201 through 204 (e.g., outlet configuration, voltage, amperage, phase, connector type, color code, etc.), and
iv. power outlets 121-h through 132-h, and
v. rack cabinets 141 through 152 (e.g., dimensions, physical space, electrical space, type of equipment accepted by the rack cabinet, type of mounting that applies, etc.), and
vi. floor PDUs 111 through 114 (e.g., voltage, amperage, phase, etc.), and
vii. power supply 101 (e.g., voltage, amperage, phase, etc.).
   Assets database 402 can describe other characteristics of other assets within data center 100, in addition to or different from those enumerated above.

Video display 403 is a display device (e.g., a monitor, etc.) as is well known in the art that receives a video signal and creates a visual image of the signal for presentation to an operator. In accordance with the illustrative embodiment, display 403 receives the signals that are generated as described below and presents the information to the operator. It will be clear to those skilled in the art, after reading this specification, how to make and use video display 403.

Keyboard 405 is a character input device as is well known in the art that receives input from an operator and transmits keyboard signals representing that input. It will be clear to those skilled in the art, after reading this specification, how to make and use keyboard 405.

Pointing device 406 is a spatial input device (e.g., a mouse, a joystick, a touchpad, a stylus, etc.) as is well known in the art that receives spatial and command (e.g., button, wheel, etc.) input from an operator and that transmits pointing and command signals representing that input. It will be clear to those skilled in the art, after reading this specification, how to make and use pointing device 406.

In accordance with the illustrative embodiment, asset management system 291 performs at least some of the operations described below. As those who are skilled in the art will appreciate after reading this specification, however, a different system can perform some or all of said operations.

FIG. 5 depicts a block diagram of the salient components of data-processing system 401, in accordance with the illustrative embodiment. Data-processing system 401 is a computing device and comprises input interface 501, processor 502, memory 503, output interface 504, and network interface 505 interconnected as shown. In accordance with the illustrative embodiment, data-processing system 401 is a personal computer.

Input interface 501 (e.g., a USB interface, etc.) receives signals from keyboard 405 and pointing device 406, and forwards the information encoded in the signals to processor 502. It will be clear to those skilled in the art, after reading this specification, how to make and use input interface 501.

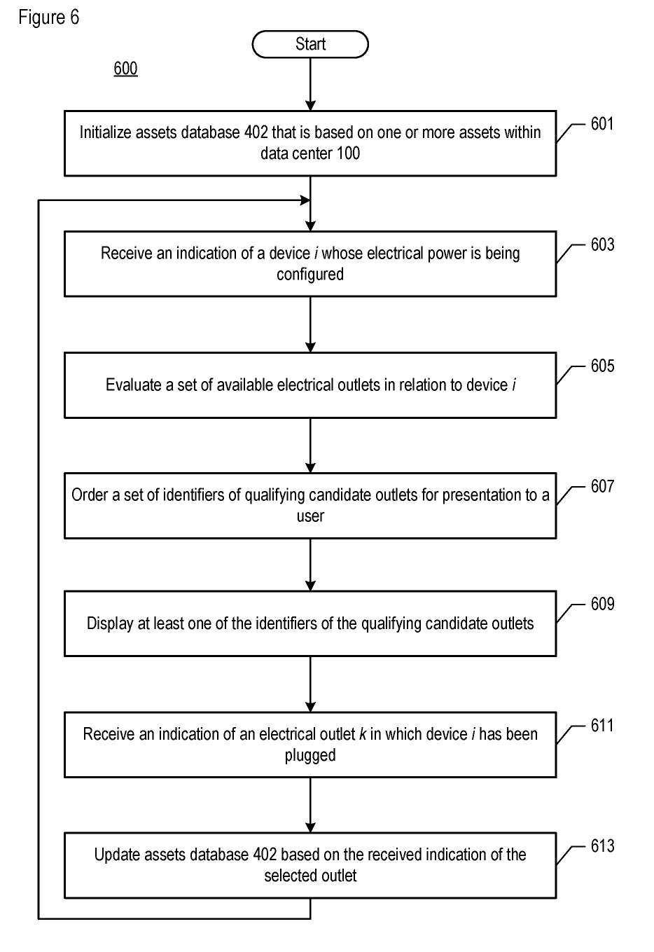

Processor 502 is a general-purpose processor that is capable of, in accordance with the operations described in regard to FIGS. 6 through 9: receiving information from input interface 501; reading data from and writing data into memory 503; executing at least some of the operations described below; and transmitting information to output interface 504 (e.g., browser-related information, etc.). In some alternative embodiments of the present invention, processor 502 might be or might comprise a special-purpose processor, such as a graphics-processing unit (GPU). In either case, it will be clear to those skilled in the art, after reading this specification, how to make and use processor 502.

Memory 503 stores data and executable instructions, is a combination of volatile and non-volatile memory, and is non-transitory. It will be clear to those skilled in the art, after reading this specification, how to make and use memory 503.

Output interface 504 (e.g., a USB interface, etc.) receives information from processor 502, and outputs signals that encode this information to video display 403. In some embodiments, output interface 504 can be built into a video card, which can be used to offload at least some of the processing from processor 502. It will be clear to those skilled in the art, after reading this specification, how to make and use output interface 504.

Network interface 505 receives one or more datasets from assets database 402. In some alternative embodiments of the present invention, the datasets are made available to data-processing system 401 through other means. Network interface 505 transmits one or more updated datasets to assets database 402. Interface 505 also communicates via LAN 292 to one or more rack-mounted devices and other devices within data center 100. It will be clear to those skilled in the art, after reading this specification, how to make and use network interface 505.

As those who are skilled in the art will appreciate after reading this specification, the hardware platform performing at least some of the operations performed by data-processing system 401 can be embodied as a multi-processor platform, as a sub-component of a larger computing platform, as a virtual computing element, or in some other computing environment all within the scope of the present invention. The steps described herein can be performed in a single processor, or distributed across multiple processors. Furthermore, data-processing system 401 can be a type of apparatus different than a personal computer, such as a server computer, and can be referred to by a different name such as a computer system, a computing device, or another type of hardware platform that comprises one or more processors, one or more memories, and one or more network interfaces, for example and without limitation.

In accordance with the illustrative embodiment, data-processing system 401 runs at least some of the software associated with dcTrack® by Sunbird Software, Inc. in order to provide at least some of the assets database functionality.

FIG. 6 depicts a flowchart of the salient processes of method 600 for configuring how electrical power is distributed to one or more devices, performed in accordance with the illustrative embodiment and comprising operations that are depicted as being executed a particular order. It will be clear to those having ordinary skill in the art, after reading the present disclosure, how to make and use alternative embodiments of method 600, as well as the other methods disclosed in this specification, wherein the recited operations sub-operations, and messages are differently sequenced, grouped, or sub-divided—all within the scope of the present disclosure. It will be further clear to those skilled in the art, after reading the present disclosure, how to make and use alternative embodiments of the disclosed methods wherein some of the described operations, sub-operations, and messages are optional, are omitted, or are performed by other elements and/or systems.

For pedagogical purposes, the operations associated with the disclosed system and method are presented as being sequentially performed. As those who are skilled in the art will appreciate after reading this specification, at least some of the operations disclosed herein can be performed in parallel with one another.

The configuring techniques disclosed in FIG. 6 and related figures are depicted as being performed by data-processing system 401 within asset management system 291. As those who are skilled in the art will appreciate after reading this specification, however, these disclosed techniques can be performed elsewhere.

In accordance with operation 601, data-processing system 401 initializes assets database 402, which describes at least some characteristics of at least some of the assets within data center 100. System 401 initializes assets database 402 to store a current description of some or all of the identifiers and features listed above and in regard to the description of database 402 in FIG. 4. In some embodiments of the present invention, database 402 comprises a description of the attributes that describe the tree graph depicted in FIG. 3, including the vertices and edges along with their identifiers and features.

Database 402, in some embodiments, is initialized to provide an initial “snapshot” of each unpopulated rack cabinet; the database is then updated also to include the equipment units as they are populated in each rack cabinet. In some embodiments of the present invention, assets database 402 is configured manually. In other embodiments data-processing system 401 can import a spreadsheet or other type of computer file that describes one or more aspects of the equipment configuration within data center 100.

In accordance with operation 603, data-processing system 401 receives an indication of a particular device i whose electrical power is being configured by an operator (e.g., a technician, etc.). In some embodiments of the present invention, the operator indicates the device by selecting, in the assets database, the rack-mounted device (e.g., server 211, etc.) whose power cable is ready to be plugged into an electrical outlet on a rack PDU (e.g., PDU 201, PDU 202, etc.).

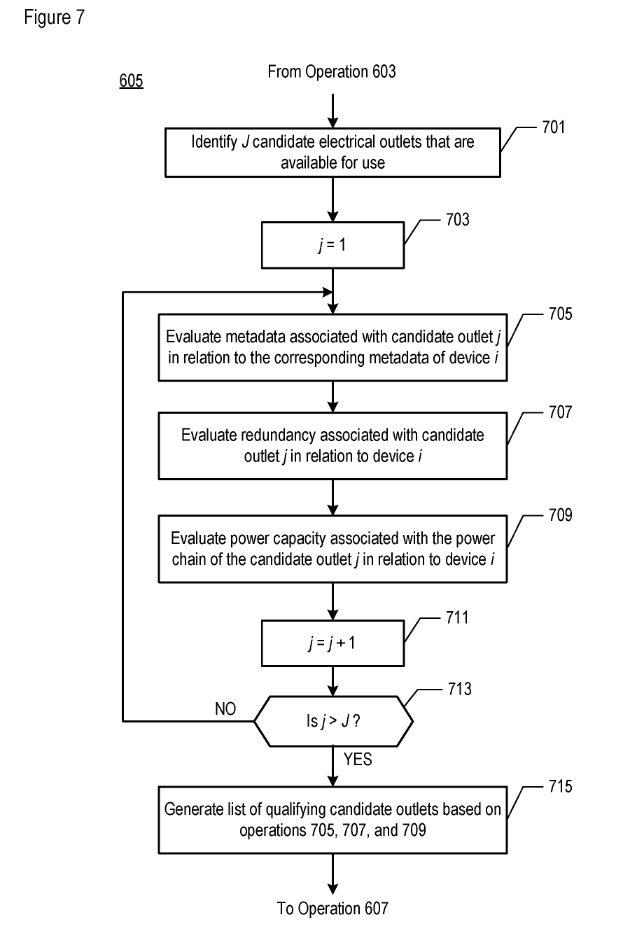

In accordance with operation 605, data-processing system 401 evaluates a set of available electrical outlets in relation to the selected device i. Operation 605 is described below and in regard to FIG. 7.

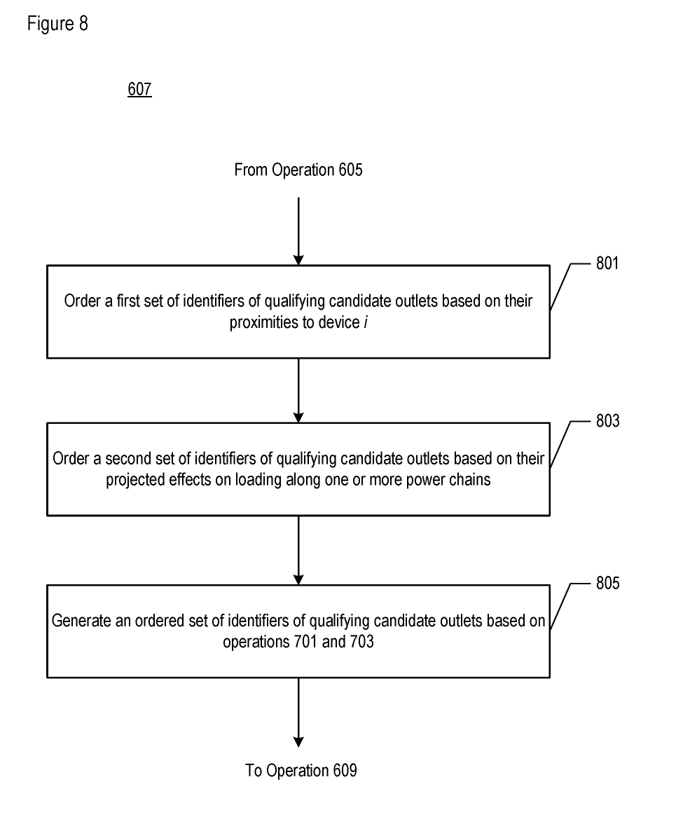

In accordance with operation 607, data-processing system 401 orders a set of identifiers of qualifying candidate outlets for presentation to the operator. Operation 607 is described below and in regard to FIG. 8.

In accordance with operation 609, data-processing system 401 displays, on video display 403, at least one of the identifiers of the qualifying candidate outlets along with an identifier of device i. In some embodiments of the present invention, system 401 displays the identifier or identifiers of the qualifying candidate outlets such that they can be visually correlated with the identifier of device i (e.g., are displayed relatively near the device's identifier on the display compared with other information being displayed, etc.).

In accordance with operation 611, data-processing system 401 receives an indication of a particular electrical outlet k into which the operator has chosen to plug the power cable of device i. In some embodiments of the present invention, the operator indicates the electrical outlet by selecting, in the assets database, the particular electrical outlet on a rack PDU (e.g., PDU 201, PDU 202, etc.) and by confirming the rack-mounted device whose power cable is being plugged into the outlet. In some other embodiments of the present invention, the affected rack PDU senses that a power cable has been plugged into a particular outlet and reports the event to system 401.

In accordance with operation 613, data-processing system 401 updates assets database 402 in response to and based on the indication of the chosen outlet, received in accordance with operation 611. For example, selected outlet k on the affected rack PDU is now marked in the database as being unavailable. In some embodiments of the present invention, system 401 updates a representation in the database of the tree graph depicted in FIG. 3.

After operation 613, control of task execution proceeds to operation 603, in which data-processing system may receive a new indication of a new device whose electrical power is being configured by the operator, wherein the operations of method 600 are subsequently performed based on the indication of the new device and using the updated assets database.

FIG. 7 depicts the sub-operations within operation 605, related to evaluating a set of available electrical outlets in relation to selected device i. In accordance with operation 701, data-processing system 401 identifies J candidate electrical outlets that are available for use (i.e., that are unused) on one or more rack PDUs, wherein the value for J is equal to the number of such outlets identified. In some embodiments, J amounts to a plurality (i.e., more than one) of candidate outlets, and the value of J is based on one or more features of device i. In accordance with the illustrative embodiment, system 401 queries assets database 402 to obtain a list of currently available outlets on rack PDUs that are mounted on or near the rack cabinet that is housing device i. For example, this would mean all available outlets on rack PDUs 201 and 202 if server 211 is being considered. In some embodiments of the present invention, availability information can be inferred from signals provided by one or more PDUs (e.g., signals indicating power being drawn from an outlet, signals indicating something is or is not plugged into an outlet, etc.) and received via LAN 292.

In some embodiments of the present invention, system 401 queries assets database 402 to obtain a list of currently available outlets on rack PDUs that are within a predetermined distance of device i. For example, a query specifying all outlets within two cabinets of distance from server 211 might produce a list of outlets that also includes rack PDUs 251 and 252, in addition to rack PDUs 201 and 202. As another example, a query specifying all outlets within one meter of distance from server 211 might produce a list of outlets that consists of only a proper subset of the available outlets on rack PDUs 201 and 202.

After initializing counter j to be equal to one at operation 703, data-processing system 401 starts evaluating the J candidate outlets. In accordance with operation 705, data-processing system 401 evaluates the metadata associated with candidate outlet j in relation to the corresponding metadata of device i. For example and without limitation, system 401 can evaluate one or more of the following metadata items:
i. voltage provided at outlet (e.g., 120 V, 208 V, etc.) versus required by device, and
ii. amperage provided versus required, and
iii. phase configuration provided (e.g., three-phase configuration, single-phase configuration, etc.) versus required, and
iv. connector type of outlet versus connector type of device's power cable, and
v. color code of outlet versus color code of power cable.
   Data-processing system 401 can evaluate other metadata items, in addition to or different from those enumerated above.

In accordance with the illustrative embodiment, in evaluating one or more metadata items associated with candidate outlet j in relation to that of device i, data-processing system 401 marks outlet j as qualifying only if all metadata items being evaluated match and/or are compatible between those of the outlet and those of the device. In some alternative embodiments, system 401 marks outlet j as qualifying even if only a non-empty subset of the metadata items matches and/or is compatible between outlet and device. In at least some embodiments of the present invention, data-processing system 401 can score the degree to which the metadata items match and/or are compatible between outlet j and device i; in some cases, a score can be numerical, while in other cases, a score can be binary (e.g., “yes” or “no”, etc.).

In accordance with operation 707, data-processing system 401 evaluates a predetermined type of redundancy associated with candidate outlet j in relation to device i. Redundancy itself can be evaluated respect to either device i or the rack cabinet in which device i resides. In accordance with the illustrative embodiment, system 401 evaluates the power redundancy associated with candidate outlet j in relation to device i. In evaluating power redundancy with respect to device i, the device has at least two power supplies, the first power supply is already plugged into a rack PDU outlet, and the evaluation determines whether or not candidate outlet j being considered for plugging in the second power supply provides a sufficiently independent power chain with respect to the power chain associated with the first power supply.

In accordance with the illustrative embodiment, data-processing system 401 evaluates whether any power redundancy is associated with candidate outlet j in relation to device i. In some other embodiments of the present invention, system 401 evaluates the degree of power redundancy. The different degrees can include, for example and without limitation: redundancy within a rack PDU, redundancy across rack PDUs, redundancy across cabinet power outlets, redundancy across floor PDUs, and so on. In at least some embodiments of the present invention, data-processing system 401 can score the degree of redundancy (i.e., power or otherwise) associated with candidate outlet j in relation to device i. For example, scoring can be based on how close to the root of the tree graph in FIG. 3 do the redundant power chains diverge for a given rack-mounted device such as server 211.

In some embodiments of the present invention, data-processing system 401 evaluates the power redundancy based in part on power-metering information that it receives from at least one PDU via LAN 292.

In accordance with operation 709, data-processing system 401 evaluates a power capacity associated with candidate outlet j in relation to device i. Data-processing system 401 can evaluate the power capacity at each level of power distribution along a power chain. For example, in considering outlet j on rack PDU 201 in relation to server 211 (as device i), system 401 can project whether the use of the outlet will cause the rated load on rack PDU 201 to exceed a predetermined level (e.g., 50 percent of NEC rated load when accounting for power redundancy across two rack PDUs); if so, outlet j can be marked or scored as such in order to discount outlet j as a possible choice.

As part of considering the effects on power loading, data-processing system 401 can account for the power loading on each phase of electrical power, wherein different outlets, even on the same PDU, can have different effects on each phase's power loading for a given power chain. While evaluating this, system 401 can consider an objective of how well the loads are balanced across the phases (i.e., phase balancing) in a polyphase power chain (e.g., three-phase, etc.), or of not exceeding a predetermined level in any phase, or both. A phase-balancing objective can be based on one or more considerations such as, while not being limited to, i) the ratio of the projected load of the most-loaded phase to that of the least-loaded phase not exceeding a predefined value, ii) the projected load of each phase not deviating from a predefined first value by more than a predefined second value, iii) the maximum difference in the projected loads of the different pairs of phases not exceeding a predefined value, and so on.

Data-processing system 401 can also evaluate the power capacity at other levels of the power distribution along a power chain. Other levels can include the floor PDU level, for example and without limitation, as a floor PDU can potentially become overloaded, in addition to or even before one or more rack PDUs become overloaded. In at least some embodiments of the present invention, data-processing system 401 can score the power capacity associated with candidate outlet j in relation to device i, at one or more levels of power distribution.

In some embodiments of the present invention, data-processing system 401 evaluates the power capacity based in part on power-metering information that it receives from at least one PDU via LAN 292.

In accordance with operation 711, data-processing system 401 increments counter j. If the value of counter j is greater than J (i.e., the number of available electrical outlets under consideration) as determined at operation 713, control of task execution proceeds to operation 715. Otherwise, control of task execution proceeds back to operation 705 in order to evaluate the next outlet j in relation to device i.

In accordance with operation 715, data-processing system 401 generates a set (e.g., a list, etc.) of qualifying candidate outlets based on one or more of operations 705, 707, and 709. In accordance with the illustrative embodiment, system 401 generates the set of qualifying candidates by determining whether each candidate outlet meets or exceeds a predetermined minimum set of criteria. In some embodiments of the present invention, system 401 uses the scores generated for one or more of said operations in order to determine whether said set of criteria is met or exceeded.

FIG. 8 depicts the sub-operations within operation 607, related to ordering a set of identifiers of qualifying candidate outlets for presentation to the operator. In accordance with operation 801, data-processing system 401 orders the identifiers within a first set of qualifying candidate outlets based on their proximities to device i. In accordance with the illustrative embodiment, system 401 ranks the qualifying candidate outlets in terms of their distances from device i, for example, ranked from nearest to device i (highest rank) to farthest from device i (lowest rank).

In accordance with operation 803, data-processing system 401 orders the identifiers within a second set of qualifying candidate outlets based on their projected effects on power loading along one or more power chains within data center 100. This can be used, for example, to minimize the possibility of oversubscribing and overloading along one or more power chains, with respect to power usage. In accordance with the illustrative embodiment, system 401 ranks the qualifying candidate outlets from least loading of a power chain or chains to most loading of a power chain or chains. For example and without limitation, data-processing system 401 might rank higher an outlet on rack PDU 202 than an outlet on rack PDU 201, even if rack PDU 201 has qualifying outlets possibly outlets that are even closer physically to device i than those of PDU 202 and is not yet being used at a predetermined maximum loading level.

As part of ranking based on the power loading, data-processing system 401 can account for the power loading on each phase of electrical power, wherein different outlets, even on the same PDU, can have different effects on each phase's power loading for a given power chain. As part of the ranking criteria, system 401 can consider an objective of how well the loads are balanced across the phases (i.e., phase balancing) in a polyphase power chain (e.g., three-phase, etc.), or of not exceeding a predetermined level in any phase, or both. A phase-balancing objective can be based on one or more considerations such as, while not being limited to, i) the ratio of the projected load of the most-loaded phase to that of the least-loaded phase not exceeding a predefined value, ii) the projected load of each phase not deviating from a predefined first value by more than a predefined second value, iii) the maximum difference in the projected loads of the different pairs of phases not exceeding a predefined value, and so on.

In some embodiments, data-processing system 401 tracks the actual outlet chosen by the operator, for each device i, as indicated in accordance with operation 611; system 401 does this to predict where the operator might be inclined to select the next outlet, such as on rack PDU 201. In doing so, system 401 can rank one or more of the predict outlet choices lower, to guide the operator to select a different outlet, such as on rack PDU 202. For example and without limitation, data-processing system 401 might rank higher an outlet on rack PDU 202 than an outlet on rack PDU 201, specifically in order to break a detected pattern of the operator exhausting the resources on rack PDU 201 first; the detected pattern might be that M of the last N operator choices (M less than or equal to N), as detected in operation 611, have been outlets on rack PDU 201.

In accordance with operation 805, data-processing system 401 generates an ordered set (e.g., an ordered list, etc.) of identifiers of the qualifying candidate outlets based on one or both of operations 801 and 803. In some embodiments of the present invention, system 401 uses the scores generated for one or more of said operations depicted in FIG. 7, in order to generate the ordered set, in addition to or instead of the rankings described above and in regard to operations 801 and 803.

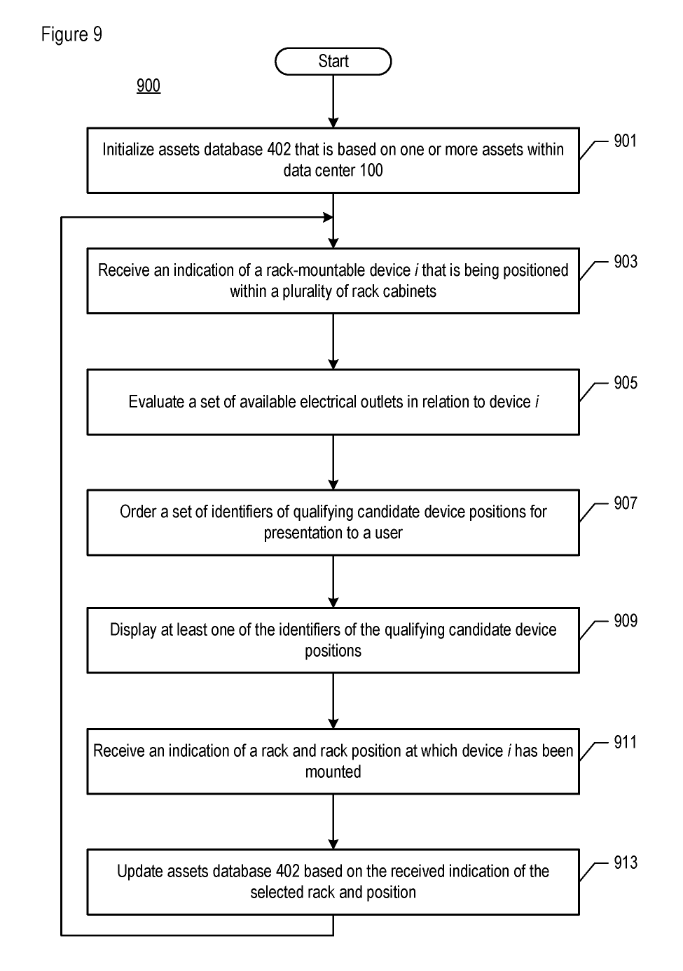

FIG. 9 depicts a flowchart of the salient processes of method 900 for configuring, within a group of rack cabinets, one or more rack-mounted devices to which electrical power is provided, in accordance with the illustrative embodiment.

As disclosed above and in regard to method 600, data-processing system 401 is able to evaluate and present, to an operator, one or more qualifying electrical outlets in relation to a rack-mounted device that is known to be mounted at a particular position in the rack. With a different operational scenario in mind, method 900 as described below can be used by data-processing system 401 instead to determine where to mount the device itself, in terms of the selection of the rack itself and/or in terms of the positioning of the device within a rack. For example, server 261 is depicted in FIG. 2 as already being mounted near the top of rack cabinet 142; alternatively, method 900 can be used to determine an different rack and/or rack position for server 261, either elsewhere in rack cabinet 142 or in a different rack cabinet such as rack cabinet 141.

In accordance with operation 901, data-processing system 401 initializes assets database 402, which describes at least some characteristics of at least some of the assets within data center 100. Data-processing initializes the assets database as described above and in regard to operation 601.

In accordance with operation 903, data-processing system 401 receives an indication of a particular device i that is to be positioned (e.g., installed, etc.) by an operator (e.g., a technician, etc.) somewhere within a plurality (i.e., more than one) of rack cabinets within data center 100. In some embodiments of the present invention, the operator indicates the device by selecting, in the assets database, a rack-mounted device (e.g., server 261, etc.) that is to be positioned.

In accordance with operation 905, data-processing system 401 evaluates a set of available electrical outlets in relation to the selected device i. Operation 905 is similar to what is described above and in regard to FIG. 7, with some differences. A first difference is that a larger set of available electrical outlets can be considered so that there is greater flexibility in terms of where device i can be positioned. In general, the value of J can be based on one or more features of device i, or the fact that device i is being configured in terms of its position instead of in terms of the electrical outlet that the device is to be plugged into, or both.

A second difference is that operation 715 can be adapted as follows in order to generate a set of qualifying candidate device positions. First, data-processing system 401 generates a set of qualifying outlets based on one or more of operations 705, 707, and 709. In accordance with the illustrative embodiment, system 401 generates the set of qualifying outlets by determining whether each outlet meets or exceeds a predetermined minimum set of criteria. In some embodiments of the present invention, system 401 can use the scores generated for one or more of said operations in order to determine whether said set of criteria is met or exceeded. Then, data-processing system 401 can generate the set (e.g., a list, etc.) of the qualifying candidate device positions by checking in assets database 402 i) which racks and positions within each rack are relatively near the qualifying outlets and ii) whether sufficient physical and/or electrical space exists at those positions for device i.

In accordance with operation 907, data-processing system 401 orders a set of identifiers of qualifying candidate device positions for presentation to the operator. In accordance with the illustrative embodiment, system 401 orders the device positions within a set of qualifying candidate device positions based on their projected effects on power loading along one or more power chains within data center 100. In some embodiments of the present invention, system 401 orders the device positions based on the power loading on each phase of electrical power as described earlier, or based on an objective of phase balancing as described earlier, or both. In some embodiments of the present invention, system 401 can order the device positions within the set of qualifying candidate device positions based on different criteria than effect on power loading.

In accordance with operation 909, data-processing system 401 displays, on video display 403, at least one of the identifiers of the qualifying candidate device positions along with an identifier of device i. In some embodiments of the present invention, system 401 displays the identifier or identifiers of the qualifying device positions such that they can be visually correlated with the identifier of device i (e.g., are displayed relatively near the device's identifier on the display compared with other information being displayed, etc.).

In accordance with operation 911, data-processing system 401 receives an indication of a particular rack and/or rack position at which the operator has chosen to position device i.

In accordance with operation 913, data-processing system 401 updates assets database 402 in response to and based on the indication of the chosen rack and rack position, received in accordance with operation 911. For example, the particular position within the particular rack chosen by the operator is now marked in the database as being occupied and, as such, unavailable. In some embodiments of the present invention, system 401 updates a representation in the database of the tree graph depicted in FIG. 3.

After operation 913, control of task execution proceeds to operation 903, in which data-processing system may receive a new indication of a new device that is being positioned by the operator, wherein the operations of method 900 are subsequently performed based on the indication of the new device and using the updated assets database.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
storing in a database, by a data-processing system, identifiers of electrical outlets and identifiers of one or more devices;
receiving, by the data-processing system, an indication of a first device whose electrical power is being configured, wherein the first device is rack-mountable;
identifying, by the data-processing system, a plurality of candidate electrical outlets that are available for use;
evaluating, by the data-processing system, i) metadata of each electrical outlet in the plurality of candidate electrical outlets, in relation to metadata of the first device, and ii) power redundancy associated with each electrical outlet in the plurality of candidate electrical outlets in relation to the first device, resulting in a non-empty set of qualifying candidate electrical outlets;
ordering, by the data-processing system, the set of identifiers that correspond to the qualifying candidate electrical outlets; and
displaying on a video display, by the data-processing system, the set of ordered identifiers of the qualifying candidate electrical outlets and the identifier of the first device.

2. The method of claim 1 wherein the candidate electrical outlets are part of at least one rack power distribution unit (PDU).

3. The method of claim 1 wherein the identifying of the plurality of candidate electrical outlets is based on a feature of the first device.

4. The method of claim 1 further comprising evaluating power capacity associated with a power chain of each electrical outlet in the plurality of candidate electrical outlets in relation to the first device, wherein the set of qualifying candidate electrical outlets is also based on the evaluating of the power capacity, and wherein the evaluating of the power capacity is based on power-metering information that is received by the data-processing system from at least one power distribution unit (PDU) via a local area network.

5. The method of claim 1 wherein the evaluating of power redundancy accounts for power loading at a rack PDU not exceeding a predetermined level, wherein the rack PDU is that of at least one electrical outlet being considered.

6. The method of claim 1 wherein the evaluating of power redundancy accounts for power loading at a floor PDU not exceeding a predetermined level, wherein the floor PDU is along the power chain of at least one electrical outlet being considered, and wherein the floor PDU is electrically closer to a mains power supply along the power chain than is the rack PDU of the electrical outlet being considered.

7. The method of claim 1 wherein the ordering of the set of identifiers that correspond to the qualifying candidate electrical outlets is based on a ranking of the distances of the qualifying candidate electrical outlets to the first device.

8. The method of claim 1 wherein the ordering of the set of identifiers that correspond to the qualifying candidate electrical outlets is based on a ranking of how well a usage by the first device of each qualifying candidate electrical outlet achieves a phase-balancing objective.

9. A method comprising:
storing in a database, by a data-processing system, identifiers of electrical outlets and identifiers of one or more devices;
receiving, by the data-processing system, an indication of a first device whose electrical power is being configured, wherein the first device is rack-mountable;
identifying, by the data-processing system, a plurality of candidate electrical outlets that are available for use;
evaluating, by the data-processing system, i) metadata of each electrical outlet in the plurality of candidate electrical outlets, in relation to metadata of the first device, and ii) power capacity associated with a power chain of each electrical outlet in the plurality of candidate electrical outlets in relation to the first device, resulting in a non-empty set of qualifying candidate electrical outlets, wherein the evaluating of the power capacity is based on power-metering information that is received by the data-processing system from at least one power distribution unit (PDU) via a local area network;
ordering, by the data-processing system, the set of identifiers that correspond to the qualifying candidate electrical outlets; and
displaying on a video display, by the data-processing system, the set of ordered identifiers of the qualifying candidate electrical outlets and the identifier of the first device.

10. The method of claim 9 wherein the candidate electrical outlets are part of at least one rack PDU.

11. The method of claim 9 wherein the identifying of the plurality of candidate electrical outlets is based on a feature of the first device.

12. The method of claim 9 wherein the evaluating of power capacity accounts for the power capacity of the rack PDU of each electrical outlet being considered.

13. The method of claim 9 wherein the evaluating of power capacity accounts for the power capacity of the floor PDU along the power chain of each electrical outlet being considered, wherein the floor PDU is electrically closer to a mains power supply along the power chain than is the rack PDU of the electrical outlet being considered.

14. The method of claim 9 wherein the evaluating of power capacity accounts for power loading at a PDU not exceeding a predetermined level, wherein the PDU is along the power chain of at least one electrical outlet being considered.

15. The method of claim 9 wherein the ordering of the set of identifiers that correspond to the qualifying candidate electrical outlets is based on a ranking of the distances of the qualifying candidate electrical outlets to the first device.

16. The method of claim 9 wherein the ordering of the set of identifiers that correspond to the qualifying candidate electrical outlets is based on a ranking of how well a usage by the first device of each qualifying candidate electrical outlet achieves a phase-balancing objective.

17. A method comprising:
storing in a database, by a data-processing system, identifiers of a plurality of rack cabinets, electrical outlets, and one or more devices, wherein the devices are rack-mountable;
receiving, by the data-processing system, an indication of a first device that is being positioned within the plurality of rack cabinets;
identifying, by the data-processing system, a plurality of electrical outlets that are available for use, wherein availability information for at least some of the electrical outlets is derived from signals that are received by the data-processing system from at least one power distribution unit (PDU) via a local area network;
evaluating, by the data-processing system, i) metadata of each electrical outlet in the plurality of electrical outlets, in relation to metadata of the first device, and ii) physical space available within each rack cabinet in the plurality of rack cabinets, in relation to the first device, resulting in a non-empty set of qualifying candidate device positions;
ordering, by the data-processing system, the set of identifiers that correspond to the qualifying candidate device positions; and
displaying on a video display, by the data-processing system, the set of ordered identifiers of the qualifying candidate device positions and the identifier of the first device.

18. The method of claim 17 further comprising evaluating power redundancy associated with each physical space available within each rack cabinet in the plurality of rack cabinets, wherein the set of qualifying candidate device positions is also based on the evaluating of the power redundancy.

19. The method of claim 18 wherein the ordering of the set of identifiers that correspond to the qualifying candidate device positions is based on a ranking of the power redundancies associated with the physical spaces available.

20. The method of claim 17 further comprising evaluating power capacity associated with each physical space available within each rack cabinet in the plurality of rack cabinets, wherein the set of qualifying candidate device positions is also based on the evaluating of the power capacity.

21. The method of claim 20 wherein the ordering of the set of identifiers that correspond to the qualifying candidate device positions is based on a ranking of the power capacities associated with the physical spaces available.

22. The method of claim 17 wherein the ordering of the set of identifiers that correspond to the qualifying candidate device positions is based on a ranking of the distances of the qualifying candidate device positions to one or more electrical outlets.

23. The method of claim 17 wherein the ordering of the set of identifiers that correspond to the qualifying candidate device positions is based on a ranking of how well a usage by the first device of an electrical outlet near each qualifying candidate device position achieves a phase-balancing objective.
